(19) United States
(12) Patent Application Publication
(10) Pub. No.: US 2006/0125843 A1
(43) Pub. Date: Jun. 15, 2006

(54) Control method remembering display angle

(75) Inventor: Stephen Chen, Changhua (TW)

Correspondence Address: BRUCE H. TROXELL;SUITE 1404, 5205 LEESBURG PIKE, FALLS CHURCH, VA, 22041, US

(73) Assignee: E-Lead Electronics Co., Ltd.

(21) Appl. No.: 11/008,931

(22) Filed: Dec. 13, 2004

(51) Int. Cl. G09G 5/00

(52) U.S. Cl. 345/619

(57) ABSTRACT

A control method capable of remembering display angle includes a circuit module which has a file access unit, a memory unit, a file adjustment unit and an image output unit. The control method includes: checking a selected symbol in at least one selected bit of the file name or data in a file while the file access unit loads an image to confirm whether the image needed to be adjusted during displaying on the screen to free users from the trouble of adjusting manually during viewing the image.

### BACKGROUND OF THE INVENTION

1. Field of the Invention

The invention relates to a control method capable of remembering display angle that inspects a selected symbol of at least one selected bit in a file name or data in a file while an image file is loaded to determine the display angle and size of an image to be output on a display screen.

2. Description of the Prior Art

Refer to FIG. 1, a conventional digital photo frame 1 mainly includes a screen 11, an adjustment key 12 and a memory card access device 13. Through the memory card access device 13, image data in the memory card may be output and displayed on the screen 11. Users can adjust the display fashion of the image data on the screen 11 through the adjustment key 12, such as inverse, turn to the left for ninety degrees, and the like.

The conventional digital photo frame 1 mentioned above generally can provide only image display function. Some have the adjustment key 12 to enable users to adjust the display angle of the image. As photographers have different habits, the pictures being taken are not always in a upright manner. Due to different backgrounds, sometimes the camera has to be turned at an angle such as ninety degrees, forty-five degrees, or the like the resulting image could be transverse. It is weird visually. Although the display angle of the picture may be adjusted through the adjustment key 12, users have to repeatedly adjust the viewing angle every time the image is accessed. It is not convenient.

### SUMMARY OF THE INVENTION

In view of the aforesaid disadvantage occurred to the conventional digital photo frame, the present invention aims to provide a control method that is capable of remembering the display angle. The control method includes: (1) accessing an image file; (2) decompressing the image file; (3) adjusting the image file; and (4) displaying on a screen. While a file access unit loads the image, it inspects a selected symbol of at least one selected bit in a file name or data in a file to determine the display angle of the image to be output on the screen.

By means of the control method of the invention, the display angle of the image may be set by users in advance so that the image will be turned to the desired angle during displaying to free the users from the trouble of adjusting manually while seeing the picture.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional digital photo frame.

FIG. 2 is a block diagram of the display device of the invention.

FIG. 3 is a block diagram of the circuit module of the display device of the invention.

FIG. 4 is a control flow chart of the invention.

FIG. 5 is a plane view of an embodiment of the digital photo frame of the invention.

FIG. 6 is a block diagram of an embodiment of the digital photo frame of the invention.

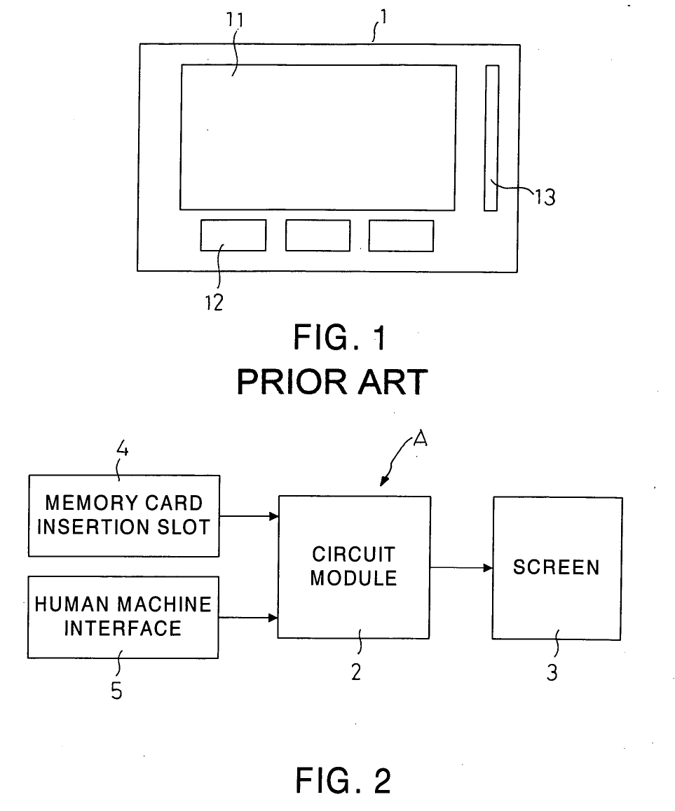

### DESCRIPTION OF THE PREFERRED EMBODIMENTS

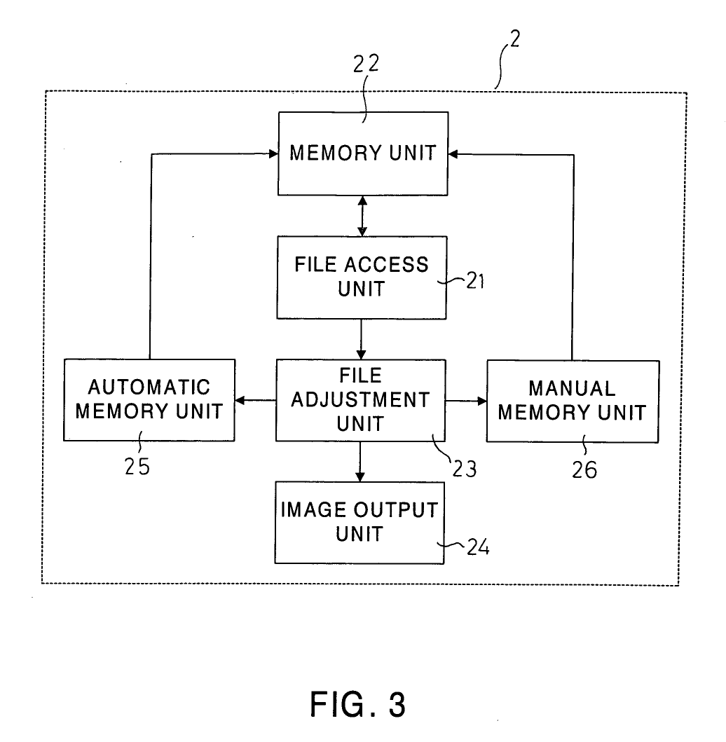

Refer to FIGS. 2 and 3 for a first embodiment of the invention. The display device A capable of remembering display angle according to the invention includes a circuit module 2, a screen 3, a memory card insertion slot 4 and a human machine interface 5.

The screen 3 aims to display images (may be a monitor or a liquid crystal display).

The memory card insertion slot 4 aims to couple with an electromagnetic recording device (such as a memory card, personal disk, hard disk, or the like).

The human machine interface 5 enables users to manually adjust the image display angle, pictures or input operations with hands (may be one or more button or rotary knob).

The circuit module 2 contains circuits to control the memory and turning of the display angle, including:

a file access unit 21 to read an image file;

a memory unit 22 to temporarily store the image file;

a file adjustment unit 23 to decompress the image file, and adjust the display angle, image turning or inverting, or the like; and

an image output unit 24 to convert the image file to pixels to be output on the screen.

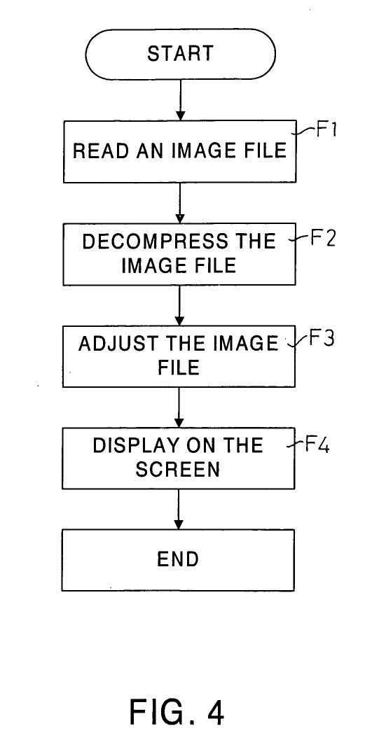

The control method of the invention, based on the elements set forth above, includes the following procedures (referring to FIGS. 3 and 4):
(1) access the image file (step F1): read data from the electromagnetic recording device (such as a memory card, personal disk, hard disk, or the like). At this step, a user inserts (or loads) the electromagnetic recording device that contains the image file into the memory card insertion slot 4 to read the image file;
(2) decompress the image file (step F2): convert the image file to pixels. The file access unit 21 reads the data of the image file to the memory unit 22, and decompresses and converts the data into pixels;
(3) adjust the image file (step F3): check the data in at least one selected bit of the file name or in the file to confirm whether the file image has to be turned and data to be processed during displaying; and
(4) display on the screen (step F4): output the adjusted pixels on the screen 3 is an image format. The file adjustment unit 23 turns the image, and the image output unit 24 converts the image file to pixels to be displayed on the screen 3. A user also can select the next image to be displayed through the human machine interface 5, or adjust the display angle of the image. The adjusted image file has a symbol affixed to the file name or data in the file to indicate the turning angle, and is stored in the memory unit 22 (or in the original electromagnetic recording device) so that when the user displays the same picture, the display angle of the image is same as the last time being viewed to free the user from the trouble of doing adjustment again.

The selected bit of the file name read by the file access unit 21 may be one bit or more from the last bit of the file name. The selected bit may contain the selected symbol to indicate the turning angle, such as 090, 180, 270 or the like to represent 90 degrees, 180 degrees, 270 degrees, or the like. Other symbols may also be used, such as +, −, =, . . . , etc. A direct record may also be entered into the data of the file, such as setting up a flag on the area to record the adjusting angle, turning or inverting or the like.

The circuit module 2 further includes an automatic memory unit 25 to automatically affix a selected symbol behind the selected bit of the file name or the data in the file according to the final turning display angle of the image so that the image may be turned automatically at the same angle when display next time.

The circuit module 2 further include a manual memory unit 26 to manually affix a selected symbol behind the selected bit of the file name or the data in the file according to the final turning of the image so that the image may be turned automatically at the same angle when display next time.

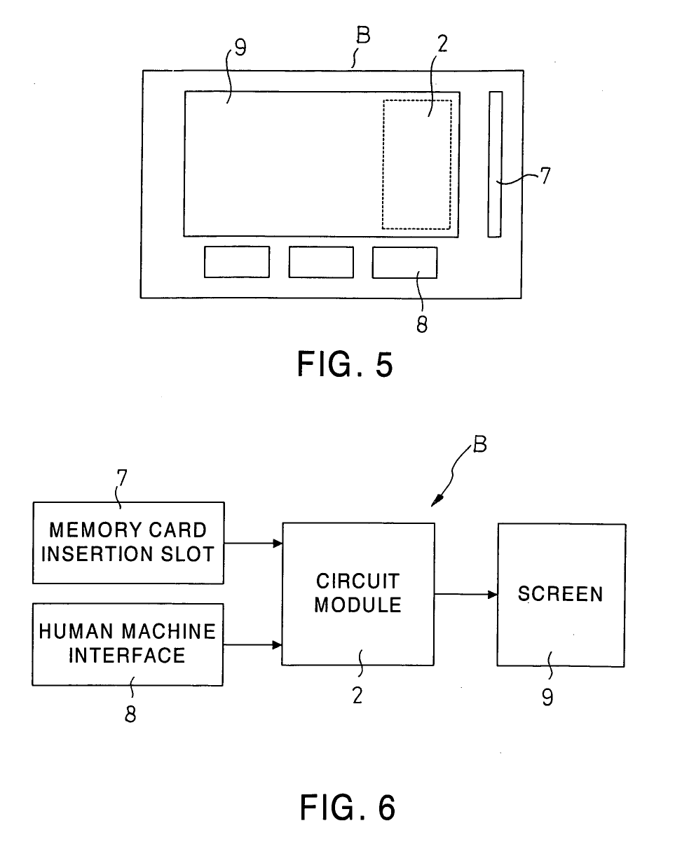

Referring to FIGS. 5 and 6 for another embodiment of a digital photo frame B that is capable of remembering the display angle according to the invention. It further includes a circuit module 2, a screen 9, a memory card insertion slot 7 and a human machine interface 8.

The screen 9 aims to display images (may be a monitor or a liquid crystal display).

The memory card insertion slot 7 aims to couple with an electromagnetic recording device (such as a memory card, personal disk, hard disk, or the like).

The human machine interface 8 enables users to manually adjust the image display angle, pictures or input operations with hands (may be one or more button or rotary knob).

The circuit module 2 is constructed and functioned as the one in the first embodiment set forth above. Namely the control method includes: a user inserting (or loading) the electromagnetic recording device (such as a memory card, personal disk, hard disk, or the like) that contains an image file into the memory card insertion slot 7; the file access unit 21 of the circuit module 2 reading the image file data to the memory unit 22; checking the selected symbol in the selected bit of the file name or data in the file when the memory unit 22 is read to confirm whether the image in the file to be turned during displaying; the file adjustment unit 23 turning the image; the image output unit 24 converting the image file to pixels to be displayed on the screen 9; a user selecting the next picture to be displayed through the human machine interface 8 or adjusting the display angle of the turning image; affixing a symbol of the turning angle to the file name of the image file after adjusted, or recording a data such as a flag in the file to indicate the adjusting angle, turning or inverting condition; storing into the memory unit 22 (or the original electromagnetic recording device) so that the display angle of the image is same as the last time being viewed to free the user from the trouble of doing adjustment again.

In summary, the control method of the invention determines whether a file image requires to be turned according to a selected symbol in at least one selected bit of the file name to free users from the trouble of repetitive adjustment every time they view the picture.

I claim:

1. A control method remembering display angle, comprising the steps of:
(1) accessing an image file to read data from an electromagnetic recording device;
(2) decompressing the image file and converting the image file to pixels;
(3) adjusting the image file to check the image file and confirm whether images of the file require turning and data processing during displaying; and
(4) outputting the adjusted pixels to a screen for displaying.

2. The control method of claim 1, wherein the adjusting the image file is to check at least one selected bit of the file name, the selected bit being at least one bit from the last bit of the file name.

3. The control method of claim 2, wherein the selected bit of the file name to be checked indicates a turning angle.

4. The control method of claim 1, wherein the file has a flag to record a turning angle of the image.

5. The control method of claim 1 further having a circuit module which includes a file access unit, a memory unit, a file adjustment unit and an image output unit.

6. The control method of claim 5, wherein the circuit module further includes an automatic memory unit to record the final turning angle of the displayed image into the image file to allow the image to be automatically turned to the same angle during displaying the next time.

7. The control method of claim 5, wherein the circuit module further includes a manual memory unit to record the final turning angle of the displayed image into the image file to allow the image to be automatically turned to the same angle during displaying the next time.
